(19) United States
(12) Patent Application Publication
(10) Pub. No.: US 2017/0274897 A1
(43) Pub. Date: Sep. 28, 2017

(54) Method and system for detecting and/or backing up video data in a motor vehicle

(71) Applicant: Continental Teves AG & Co. oHG, Frankfurt (DE)

(72) Inventors: Klaus Rink, Rodenbach (DE); Ulrich Stahlin, Eschborn (DE)

(73) Assignee: Continental Teves AG & Co. oHG, Frankfurt (DE)

(21) Appl. No.: 15/309,341

(22) PCT Filed: May 6, 2015
(86) PCT No.: PCT/EP2015/059913

§ 371 Date: Mar. 1, 2017

(30) Foreign Application Priority Data
May 6, 2014 (DE) 10 2014 208 398.2

(51) Int. Cl. B60W 30/08; G06K 9/00; G08G 1/017; G08G 1/16; G07C 5/08

(52) U.S. Cl. CPC B60W 30/08; G08G 1/162; G07C 5/0866; G08G 1/0175; G06K 9/00791; B60W 2750/40

(57) ABSTRACT

The invention relates to a method and a system for detecting and backing up video data in a motor vehicle (1), wherein the motor vehicle (1) is provided with at least camera sensors (102, 103) for detecting the video data, characterized in that the detection and/or the backup is/are triggered in an automated manner.

The invention concerns a method for detecting and/or backing up video data in a motor vehicle according to the preamble of claim 1 and a system for detecting and/or backing up video data in a motor vehicle according to the preamble of claim 9.

In the state of the art it is known to equip motor vehicles such as, for example, automobiles, trucks and motorbikes with camera sensors. The various reasons and applications for this cover a broad spectrum. By way of example, mono or stereo cameras are used as part of what is known as an Advanced Driver Assistance System (ADAS) for monitoring a space segment located in front of the vehicle and for identifying and measuring the movements of road users, carriageways, barriers and markings, etc. Reversing cameras, by way of example, are used to assist with parking maneuvers. Cameras are furthermore used to document traffic events in front of the vehicle in a circular buffer, so that in the case of accidents meaningful evidence to exonerate the driver is available. Further uses concern documentation of traffic events in front of the vehicle by the police, in order to obtain evidence proving a traffic violation, and filming the journeys of motorbikes from the cockpit to document the journey (known as speeder videos).

The use in particular for documentation of traffic events in front of the vehicle in a ring buffer is an increasingly popular application. Here it is noteworthy that from the simple “makeshift solution” of the vehicle owner through to the retrofit solution, broad scope for implementation and application exists. A solution integrated into the vehicle architecture, which also in particular meets future safety requirements of networked vehicles, e.g. as part of a trip recorder or accident data recorder system, which uses the ADAS (Advanced Driver Assistant System) sensors provided aboard a modern vehicle is not yet known, however. Therefore, backing up of the video material recorded, to prevent manipulation or data theft, is not straightforward.

Another disadvantage in the state of the art is furthermore that the decision on which part of the video clip is to be used or ultimately saved, is made manually by the driver or only the last recorded interval of time ever remains in the ring buffer.

The object of the invention is therefore to put forward a method and a system which allow efficient recording of relevant traffic situations, which is protected from unauthorized interventions and does not require any effort by the driver to operate it.

The object is achieved by a method according to claim 1 and a system according to claim 9. Further preferred embodiments are indicated by the sub-claims and the following description of exemplary embodiments. The subject matter of the sub-claims is, by reference, expressly included in the subject matter of the description.

According to the invention a method for detecting and backing up video data in a motor vehicle is proposed, wherein the motor vehicle has at least camera sensors for detecting the video data, wherein the detection and/or backing up are triggered in an automated manner.

According to the invention it is proposed that the video data are not continuously detected and if necessary backed-up. Instead, as a function of predefined criteria, serving as triggers, the intention is for detection and backing up of video data to be triggered or prompted. Here the invention makes use of the knowledge that in future vehicles camera sensors or cameras for recording moving images for autonomous driving functions will be widely used and able to be combined with other systems such as vehicle-to-X communication (hereinafter V2X or Car2X for short) and systems for performing autonomous driving. This makes it possible to also estimate and assess the content of traffic situations. The need to keep the video data in a ring buffer and to evaluate these for a given reason is in this way dispensed with. In the method according to the invention only video data that are necessary and relevant for later evaluation are automatically recorded.

In this connection, it is particularly advantageous to save only that part of the video sequence, in particular save it in an automated manner, which was recorded in the presence of a hazard situation. To detect the presence of a hazard situation the camera sensors are preferably similarly used, in particular in combination with image recognition. The camera sensors can, by way of example, be forward-view cameras, blind spot detection or reversing cameras.

Detection within the meaning of the invention is understood to relate to the detection of a traffic situation. It is not intended to be understood in the sense of pure data acquisition, but in relation to the context of a video recording. Thus it should also be distinguished from detection of image material, used for autonomous driving of a vehicle, and where the camera sensors continuously detect data. Rather, detection and backing up are intended to mean a process or a recording routine which is necessary for backing up video material on a traffic situation.

Advantageously the control or the saving of the video data or video sequences and further associated data is performed by what is known as a secure data system. The secure data system encrypts the video data for example in order to secure these against being read out in the event of unauthorized access. Control of the video sequences, thus the selection of the video sequences to be recorded or saved, is similarly performed by what is known as a secure data system, in order to avoid unauthorized access to these functions. To this end the secure data system can for example be equipped with a firewall or other suitable devices or methods known to a person skilled in the art.

It is similarly preferably provided that further sensory information (e.g. movement and position sensors, steering wheel, brake pedal, accelerator pedal position, position of the vehicle) is recorded with its respective integrity level, in order to perform a plausibility check on the movement of the vehicle itself and the driver actions. Thus the video sequence information is supplemented by additional information, simplifying the reconstruction of a filmed series of events or also supplying more relevant information.

It is further preferably provided that further information from vehicles in the detection environment networked by means of vehicle-to-X communication systems (Car2X or V2X systems) is recorded with its respective integrity level, logged and saved, in order to check the vehicle movement and the driver actions of the ‘opposite number’, that is to say the detected vehicles in the video images for plausibility.

It is similarly preferably provided that the entire data record of a hazard situation is stored securely, that is to say encrypted or secured against unauthorized access, in the Car2X system.

According to a first exemplary embodiment, what are referred to as Car2X safety apps of the V2X system, activated in the case of safety applications, are used to control and save the video sequences. Here the Car2X safety apps detect whether a hazard as a result of cooperation partners or vehicles in the environment or communication partners is present in the local ad-hoc network, and then trigger a backup of the recorded video sequence. This includes all ADAS systems, and thus also the reversing camera. The use of Car2X systems has the advantage that not only hazard situations of the vehicle itself, but also hazard situations of nearby vehicles are detectable. In this way it is possible for a driving situation in an environment with a plurality of vehicles that are communicating with each other, to be recorded from different perspectives with a system according to the invention.

According to a second exemplary embodiment, what are known as ADAS apps or applications, which are activated in the case of safety applications, are used to control and save the video sequences. Here the ADAS apps identify whether a hazard has been identified by video/radar analysis and then trigger a backup of the recorded video sequence. This includes all ADAS systems, and thus also the reversing camera.

According to a third exemplary embodiment, what are known as ADAS apps, which are for example activated by safety applications, immediately a hazard is identified by video/radar analysis, are used to trigger a backup of the recorded video sequence. This includes all ADAS systems, and thus also the reversing camera.

According to a fourth exemplary embodiment, control of the logging and backup of the video sequences is performed by the Car2X ECU (application unit), which is designed as a secure data system and also hosts the abovementioned Car2X safety apps.

According to a fifth exemplary embodiment, the sensor data and the data that has been aggregated (e.g. by means of what is referred to as the M2XPro module), are used in order to perform a plausibility check on the movement of the vehicle itself and the diver actions.

According to a sixth exemplary embodiment, a backup of the data available via the Car2X network on potential other parties, or an assignment of these data to other parties detected in the video images, is performed.

According to a seventh exemplary embodiment video data is made available to end users, e.g. by means of what is known as an HMI unit, which may also have a learning application (What happened? How could this have been handled better?).

According to an eighth exemplary embodiment, traffic monitoring is performed in special operations vehicles, such as police vehicles, with the abovementioned means, by a Car2X system and no longer by a proprietary police system.

The invention is described in more detail using an exemplary embodiment and a figure. This shows as follows:

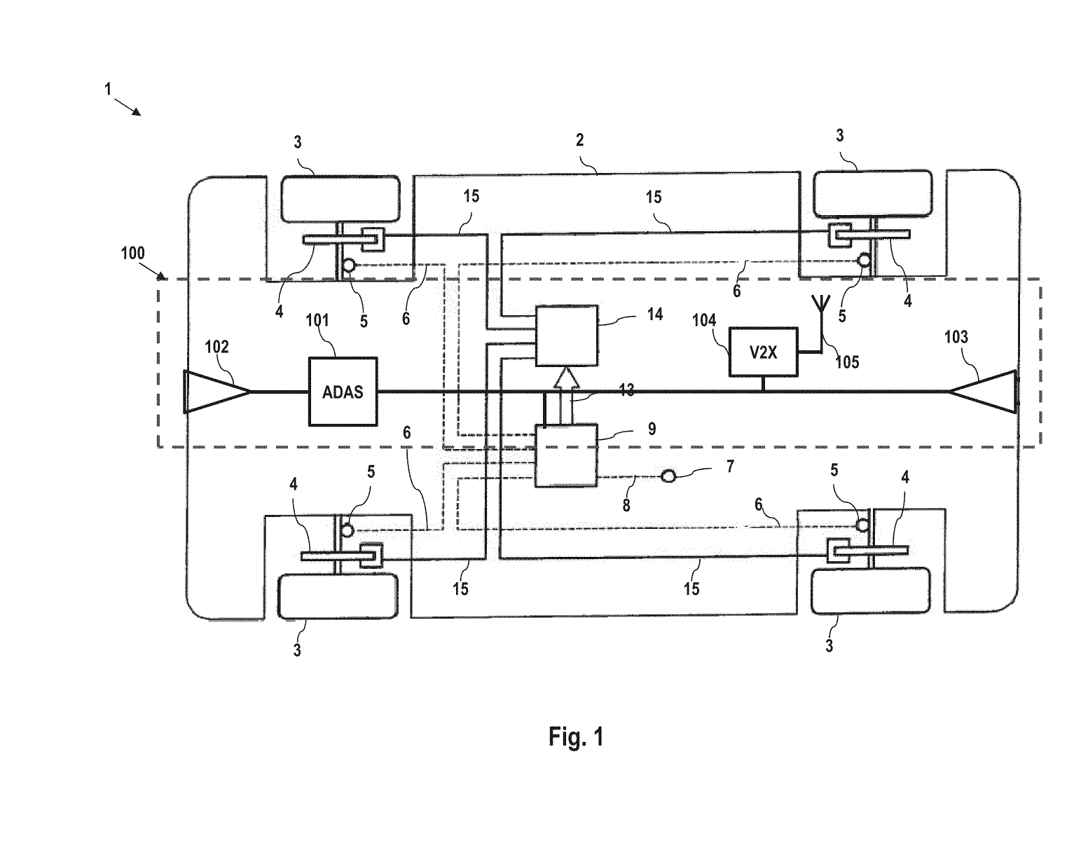

FIG. 1 is a schematic representation of a system according to the invention in a vehicle.

FIG. 1 shows a system 100 for detecting and backing up video data in a motor vehicle, installed in a vehicle 1. The system boundary is shown in FIG. 1 as a rectangle with a broken line containing the essential system elements.

The system 100 has two camera sensors or cameras 102, 103 for detecting video data, attached to the front and rear of the vehicle. Alternatively, a camera sensor could also be attached to the windshield. The use of more than three cameras is conceivable. Furthermore, the vehicle has a V2X and an ADAS (Advanced Driver Assistance System) system unit 104, 101. The cameras 102, 103 are connected to the ADAS system unit and are also used for other functions of the ADAS system unit 101. The V2X system unit 104 is connected with the ADAS system unit 101, in order to enable data exchange. The system 100 is configured so that recording, e.g. detection and backup, of video data is automatically triggered.

Triggering of recording takes place according to predefined criteria. It is in particular provided that upon identification of a hazard situation the recording is triggered. The hazard situation can be detected by the ADAS system unit 101. One possibility here is offered by the various assistance systems or other applications of the ADAS system unit 101, such as emergency steer assist, lane departure assist, brake assist and/or distance assist. If intervention by one of the assist systems is detected, then recording can simultaneously be triggered.

Alternatively, the start of recording can also be triggered via the V2X system unit 104, if this sends or receives a message containing a warning. Depending on the system configuration it is quite conceivable for the V2X to detect a hazard situation via other vehicle systems and to communicate this through a message to nearby vehicles, detected later or not at all by an ADAS system unit 101. Such a case is described below.

The vehicle 1 shown in FIG. 1 has a chassis 2 and four wheels 3, wherein each wheel 3 can be slowed in relation to the chassis 2 by means of a brake 4 secured immovably to the chassis 2, in order to slow movement of the vehicle 1 on a road that is not shown in more detail.

In the present embodiment as sensors the vehicle 1 has speed sensors 5 on the wheels 3, which detect the respective speeds 6 of the wheels 3 as measurement data. The vehicle 1 also has as a sensor an inertial measurement unit 7, which detects vehicle dynamics data 8 of the vehicle 1 as measurement data which, for example, can be used to output a pitch, a roll, a yaw rate 10 shown in FIG. 2, a lateral acceleration shown in FIG. 2, a longitudinal acceleration 12 shown in FIG. 2 and/or a vertical acceleration in a manner known to a person skilled in the art.

Based on the detected speeds 6 and vehicle dynamics data 8 a controller 9 can determine in a manner known to a person skilled in the art, whether the vehicle 1 is skidding on the road surface or perhaps deviating from the abovementioned predefined trajectory, and respond accordingly to this with a controller output signal 13 in an in itself known manner. The controller output signal 13 can then be used by a setting adjuster 14, in order to activate by means of setting signals actuators, such as the brakes 4, which respond to the skidding and deviation from the predefined trajectory in an in itself known manner.

The controller 9 can by way of example be integrated into an in itself known engine control of the vehicle 1. The controller 9 and the setting adjuster 14 can also be configured as a combined control device and optionally integrated into the abovementioned engine control.

The intervention of the controller in the brake is normally reported to the V2X system unit 104, so that this can in particular warn the following vehicles. If such a warning message is sent via the V2X system unit 104 to other vehicles, then the recording can be triggered simultaneously. Furthermore, in this way, in addition to the video data, further sensor data of the vehicle 1 itself can be detected and/or further sensor data from other road users can be detected and/or backed up. Such sensor data can be received from other vehicles via the V2X system unit 104.

Generally speaking, it is advisable that the sensor data of the vehicle itself and/or the other road users are used for plausibility checking of the video data. The actual sensor data can also be mutually checked for plausibility by means of a sensor fusion unit. Advantageously the results of the plausibility check are also backed up in order to prevent any error in evaluating the data.

Furthermore, reciprocal validation of a hazard detection for triggering recording is conceivable and provided.

The triggering involves in particular the saving of the video data in a memory, which can be housed in the ADAS system unit 101 or in the V2X system unit 104. To prevent interference with or manipulation of the recorded video data and sensor data the video data and sensor data are backed up with encryption. This can be provided for in a separate partition of a memory in the V2X system unit 104 or in the ADAS system unit 101.

It is furthermore conceivable for the detected and backed up data to be transmitted via a wireless network to predefined recipients. For example, the video data and/or sensor data can be transmitted together with an electronic emergency message to a recipient such as the police, breakdown services, or similar. This allows backing up of evidence and a simultaneous rapid assessment of the situation on the ground.

1-8. (canceled)

9. A method for at least one of detecting and backing up video data in a motor vehicle comprising:
at least one of detecting and backing up video data for the vehicle with at least camera one sensors;
automatically triggering at least one of the detecting and backing upon identification of a hazard situation; and
identifying the hazard situation with a vehicle-to-vehicle communication.

10. The method according to claim 9, wherein the hazard situation is identified with environment sensors.

11. The method according to claim 9, wherein the backing up of the video data is encrypted.

12. The method according to claim 1, wherein the camera sensors are also used by at least one vehicle safety system including a steer assist, a lane departure assist, brake assist and a distance assist system.

13. The method according to claim 9, further comprising at least one of detecting and backing up sensor data of the vehicle in addition to the video data.

14. The method according to claim 13, wherein the sensor data includes data of other road users.

15. The method according to claim 14, further comprising checking the video data for plausibility with the further sensor data.

16. A system for at least one of detecting and backing up video data in a motor vehicle comprising:
at least one camera sensors for at least one of detecting and backing up video data for the vehicle; and
a controller with instructions for:
automatically triggering at least one of the detecting and backing upon identification of a hazard situation; and
identifying the hazard situation with a vehicle-to-vehicle communication.

17. The system of claim 16, wherein the hazard situation is identified with environment sensors.

18. The system of claim 16, wherein the backing up of the video data is encrypted.

19. The system of claim 16, wherein the camera sensors are also used by at least one vehicle safety system including a steer assist, a lane departure assist, brake assist and a distance assist system.

20. The system of claim 16, further comprising at least one of detecting and backing up sensor data of the vehicle in addition to the video data.

21. The system of claim 20, wherein the sensor data includes data of other road users.

22. The system of claim 21, further comprising checking the video data for plausibility with the further sensor data.
